(19) United States
(12) Patent Application Publication
(10) Pub. No.: US 2025/0153257 A1
(43) Pub. Date: May 15, 2025

(54) Aerial Limb Saw

(71) Applicant: Austin Theodore McCormick, Meadville, MS (US)

(72) Inventor: Austin Theodore McCormick, Meadville, MS (US)

(21) Appl. No.: 18/944,927

(22) Filed: Nov. 12, 2024

Related U.S. Application Data
(60) Provisional application No. 63/599,269, filed on Nov. 15, 2023.

(51) Int. Cl. B23D 49/16; B25F 5/00; B25F 5/02

(52) U.S. Cl. CPC B23D 49/16; B25F 5/001; B25F 5/02

(57) ABSTRACT

A reciprocating saw is described. The aerial limb saw is a reciprocating saw comprised of a housing, a saw system, an angled clamp, and a battery adapter. Contained within the housing are a gear box, a motor, and a wireless control relay. The gear box is mechanically connected to the motor. A saw blade chuck is attached to the gear box. The saw system is comprised of a saw blade and a grip bracket. The saw blade is connected to the gear box via the saw blade chuck. The grip bracket is attached to a front surface of the housing. The battery adapter is attached to a rear surface of the housing. A portable rechargeable battery connects to the battery adapter. The battery adapter and the motor are both individually electrically connected to the control relay. The angled clamp is attached to a bottom surface of the housing.

### FIELD OF THE DISCLOSURE

The present invention relates to an aerial limb saw. More specifically, the present invention is a device that reaches tree limbs that are out of reach for buckets and lifts.

### BACKGROUND OF THE INVENTION

A reciprocating saw used for cutting tree branches is a versatile and powerful cutting tool. It's especially handy for outdoor tasks, providing an efficient and quick way to prune or trim tree branches. The saw features a blade that moves back and forth in a rapid, reciprocating motion, enabling it to cut through branches with ease. These saws come with different blade types and lengths, allowing users to select the appropriate blade for the specific task at hand. Blades with larger teeth are ideal for cutting through thicker branches, while finer-toothed blades can handle smaller or more delicate branches. The design of the saw allows for more flexibility and access to tight or hard-to-reach spaces, enabling users to maneuver around dense foliage or intricate tree structures. They're convenient for quick, precise cuts and are often used in gardening, landscaping, or yard maintenance. However, users should take precautions while using these saws, wearing appropriate safety gear, and understanding how to handle the tool safely and effectively. This includes holding the tool firmly, maintaining a stable stance, and avoiding contact with the saw blade or tree debris. With proper care, a reciprocating saw is an effective and efficient tool for trimming and pruning tree branches.

An objective of the present invention is to provide users with a battery-operated reciprocating saw, to help eliminate fallen tree branches on power lines. The present invention intends to provide users with a device that is mounted atop an insulated pole. In order to accomplish that, a preferred embodiment of the present invention comprises a housing, a saw system, an angled clamp, and a battery adapter, wherein the housing contains a gear box, motor, and a wireless control relay. Thus, the present invention is a battery powered reciprocating saw that is remotely controlled and activated, wherein the remote-controlled battery powered reciprocating saw is mountable.

### SUMMARY OF THE INVENTION

The present invention is a battery powered reciprocating saw. The present invention seeks to provide users with a device to be secured atop an insulated pole to reach fallen tree branches on powerlines. In order to accomplish this the present invention comprises a housing that insulates and protects the internal electronic and mechanical components. Further, the saw system allows for the user to secure various sized and shaped blades. Additionally, the angled clamp creates a connection location for an insulated pole. Further, a battery connected to the battery adapter provides power to the present invention. Thus, the present invention is a battery powered reciprocating saw that is remotely controlled and activated to be mounted atop an insulated pole.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is an internal view of one embodiment of the present invention.

FIG. 2 is a perspective view of the present invention.

FIG. 3 is a right-side view of the present invention.

FIG. 4 is a left-side view of the present invention.

FIG. 5 is a bottom view of the present invention.

FIG. 6 is a top view of the present invention.

FIG. 7 is a back view of the present invention.

FIG. 8 is a front view of the present invention.

FIG. 9 is a perspective view of the present invention.

All illustrations of the drawings are for the purpose of describing selected versions of the present invention and are not intended to limit the scope of the present invention.

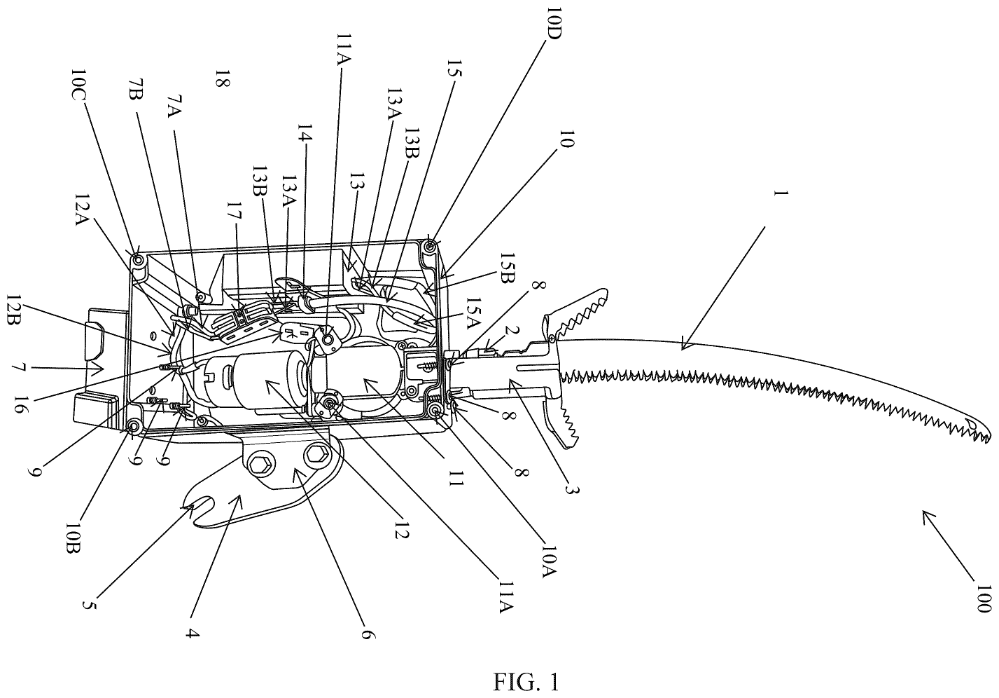

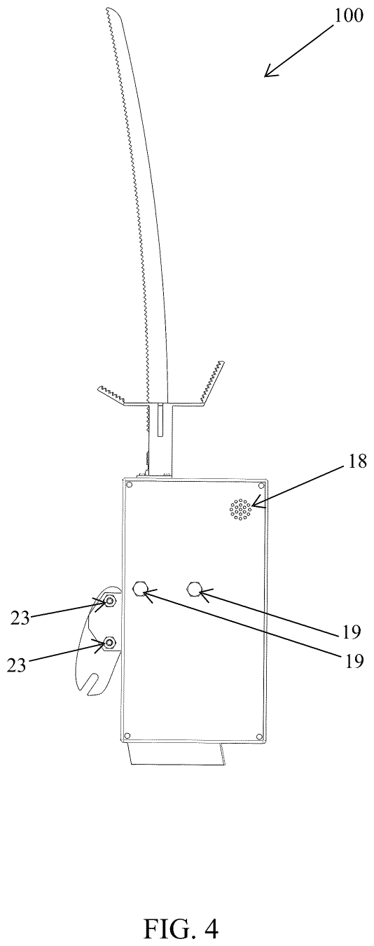

The present description includes one or more non-limiting embodiments of the present invention, an aerial limb saw 100. Referring now to FIG. 1, FIG. 1 is an internal view of an embodiment of the present invention, an aerial limb saw 100. The aerial limb saw 100 is comprised of a housing 10, a saw blade 1, a grip bracket 3, an angled clamp 4, a battery adapter 7, and a wireless remote (not displayed). Contained within the housing 10 is a gear box 11, a motor 12, and a wireless control relay 13. The gear box 11 is mechanically connected to the gear box 11. Both the gear box 11 and motor 12 are secured to the housing by gear box bolts 19 (displayed in FIG. 4) which bolt into the gear box mounting nuts 11A and 11B. The motor 12 drives the gear box 11, wherein the gear box 11 facilitates a linear back and forth motion of the attached saw 1. The wireless control relay 13 is attached to a sidewall of the housing by an attachment means.

The battery adapter 7 is attached to the housing via battery adapter screws 9. A standard portable rechargeable battery (not displayed) connects to the battery adapter 7. The portable rechargeable battery provides power to the mechanical components within the housing 10. The battery adapter 7 is wired to the wireless control relay 13 via battery adaptor wires 7A and 7B. In the present embodiment a battery wire connector 17 connects the battery adapter wires 7A and 7B to the wireless control relay wires 13A and 13B. A battery wire wrap 15A secures wireless control relay wires 13A and 13B. The wireless control relay 13 is also wired to the motor 12 via a motor wire connector 16, wherein motor wires 12A and 12B are connected to the wireless control relay wires (not displayed). Wireless control relay wires are secured by a motor wire wrap 15B. A clip clamp 14 is attached to the wireless control relay 13. The clip clamp 14 secures wireless control relay wires 13A and 13B to the wireless control relay 13.

The wireless control relay 13 is connected wirelessly to the wireless remote. The wireless remote is a handheld remote having a plurality of function control buttons that when pressed send a remote signal to the wireless motor control relay 13. One such remote signal controls the flow of power supplied by the battery to the motor 12 via the wireless control relay 13, thus turning the device either on or off. Another remote signal to the wireless motor control relay 13 controls the speed of the motor 12. The motor 12 drives the gear box 11, and thus the wireless control relay controls the reciprocating speed of the saw blade 1 by means of the wireless remote.

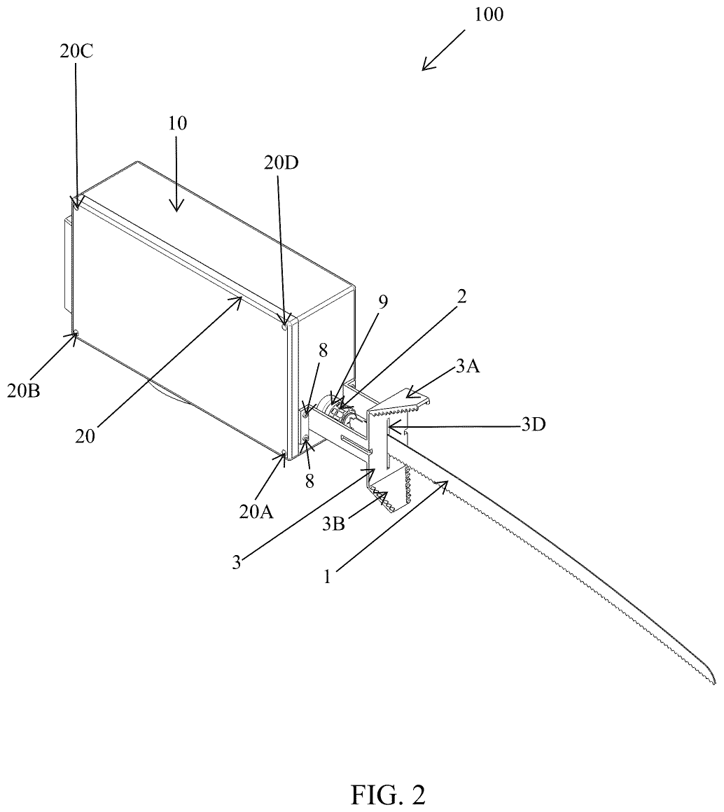

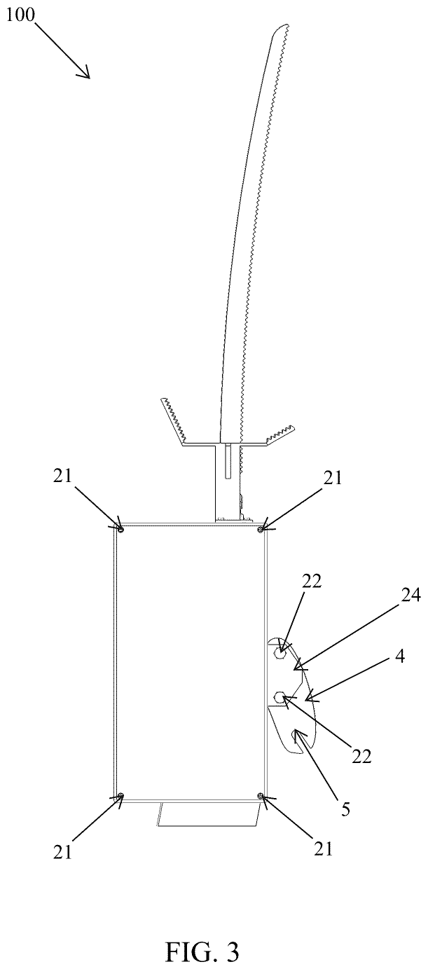

Referring to FIG. 2, FIG. 2 is right side view of an embodiment of the present invention, an aerial limb saw 100. Here a housing cover 20 is attached to the housing 10 to seal the electronic and mechanical components contained within the housing 10. The housing cover has countersink through holes 20A, 20B, 20C, and 20D wherein housing screws 21 (displayed in FIG. 3) are utilized to connect the housing cover 20 to the housing 10. The housing screws 21 screw into the housing via threaded screw holes 10A, 10B, 10C, and 10D (displayed in FIG. 1). The housing 10 has a sealed opening (not displayed) on a front surface of the housing 10 in which an adapter end of the gear box 11 extends out from the housing 10. The adapter end of the gear box 11 includes a linear motion rod 9. Attached to the liner motion rod 9 is a saw blade chuck 2. The saw blade chuck 2 is centered between the grip bracket 3 and captures the saw blade 1, wherein the saw blade 1 extends through a receiving slot 3D of the grip bracket 3.

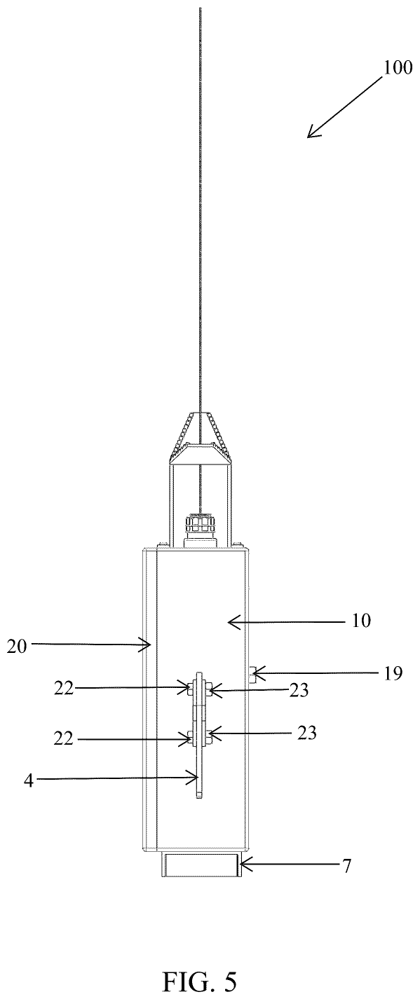

Referring to FIG. 3, FIG. 3 is a right-side view of the present invention, an aerial limb saw 100. Displayed is the angled clamp 4. The angled clamp 4 is a metal clamp component positioned along a bottom surface of the housing 10 (further displayed in FIG. 5). Angled clamp bolts 22 and angled clamp nuts 23 (displayed in FIG. 4) secure the angled clamp 4 to the housing 10 via a bracket plate 24. The angled clamp 4 is positioned such that it extends away at an angle towards the rear of the present invention. The angled clamp 4 has a C-cut 5 at a terminal end, wherein the angled clamp 4 can attach to another object. In a preferred embodiment the angled clamp 4 comprises a fastening component (not displayed) in replacement of the C-cut 5. The fastening component is a means to secure the present invention atop of an insulated pole. Attaching the present invention to an insulated pole allows an operator to place the present invention in hard-to-reach areas while ensuring the safety of the operator such that no electrical connection is created between the operator and the present invention.

Referring to FIG. 4, FIG. 4 is a left-side view of the present invention, and an aerial limb saw 100. Displayed are exhaust ports 18. The exhaust ports 18 are a multitude of holes cut through into the housing 10. The exhaust ports 18 allow for any heat produced by the internal electronic and mechanical components to be exhausted out from the housing 10 once the housing cover 20 (displayed in FIG. 2) is attached. Also displayed are the gear box mounting bolts 19. The gear box mounting bolts 19 are used to secure the gear box 11 and mechanically connected motor 12 contained within the housing 10 to a back surface of the housing 10.

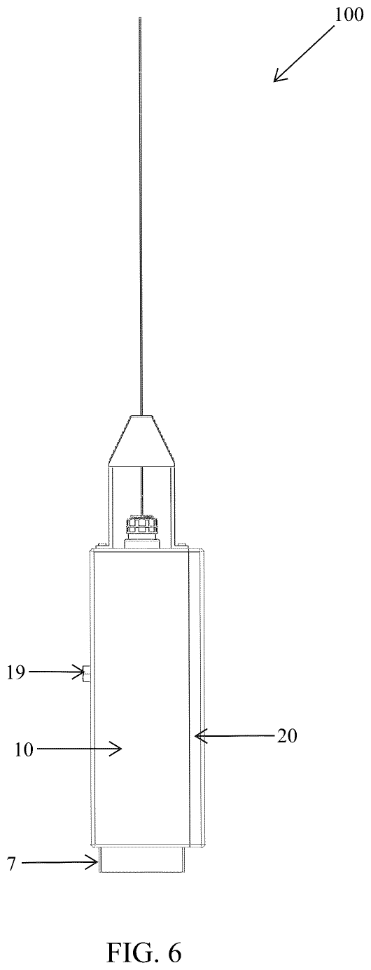

Referring to FIGS. 5 & 6, FIG. 5 is a bottom view of the present invention, an aerial limb saw 100. Displayed is the position of the angled clamp 4 with respect to the housing 10. FIG. 6 is a top view of the present invention, an aerial limb saw 100.

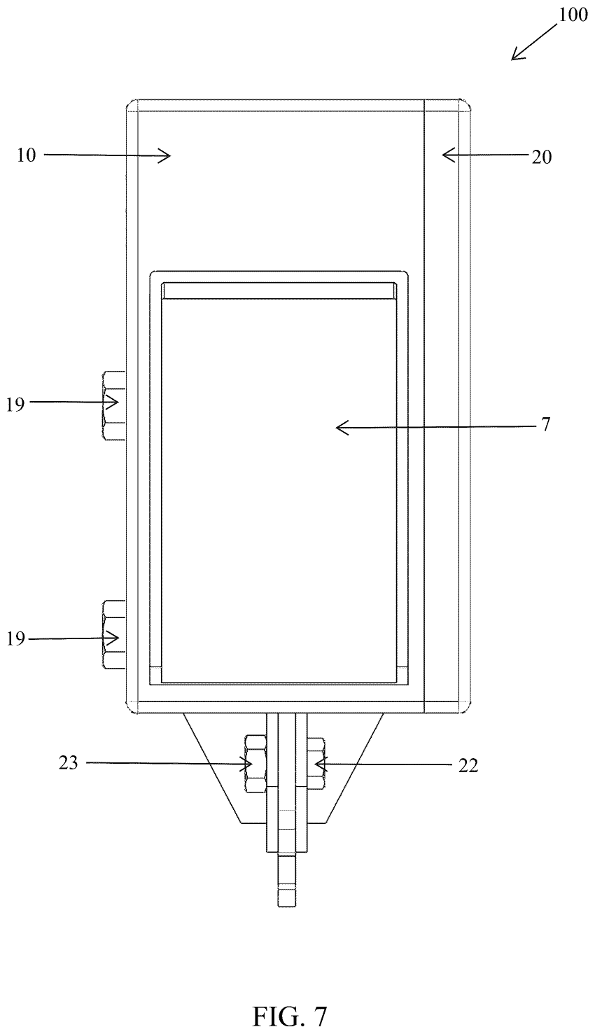

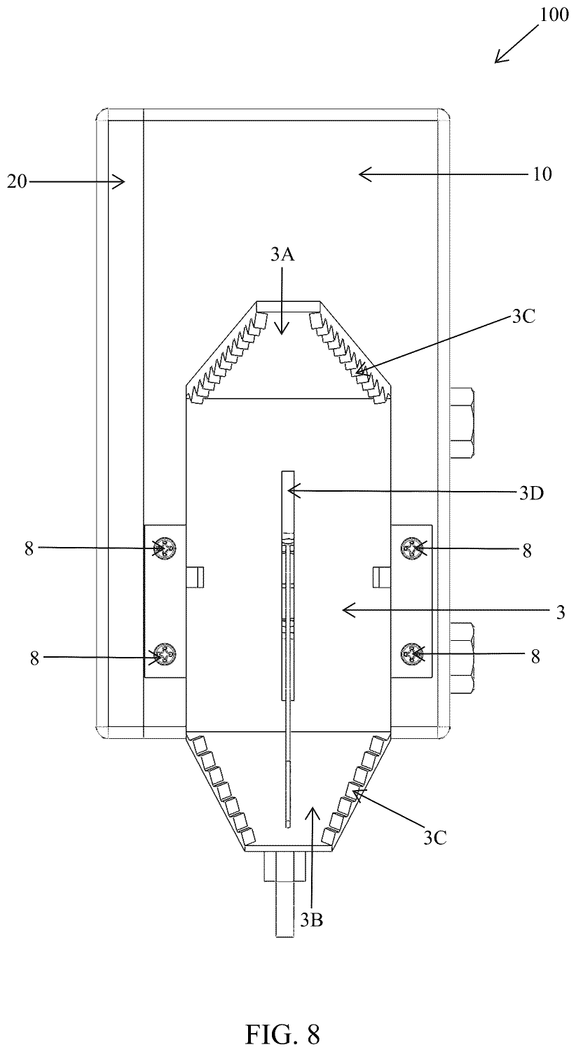

Referring to FIGS. 7 & 8, FIG. 7 is a rear view of the present invention and FIG. 8 is a front view of the present invention, an aerial saw. In FIG. 8 displayed is a closeup view of the grip bracket 3. The grip bracket 3 includes the receiving slot 3D, a top grip component 3A and a bottom grip component 3B. The top grip component 3A and bottom grip component are welded to the grip bracket 3. Both the top grip component 3A and bottom grip component 3B are comprised of teeth 3C which provide a means for the grip bracket 3 to attach and secure a branch or a limb to be cut by the saw blade 1.

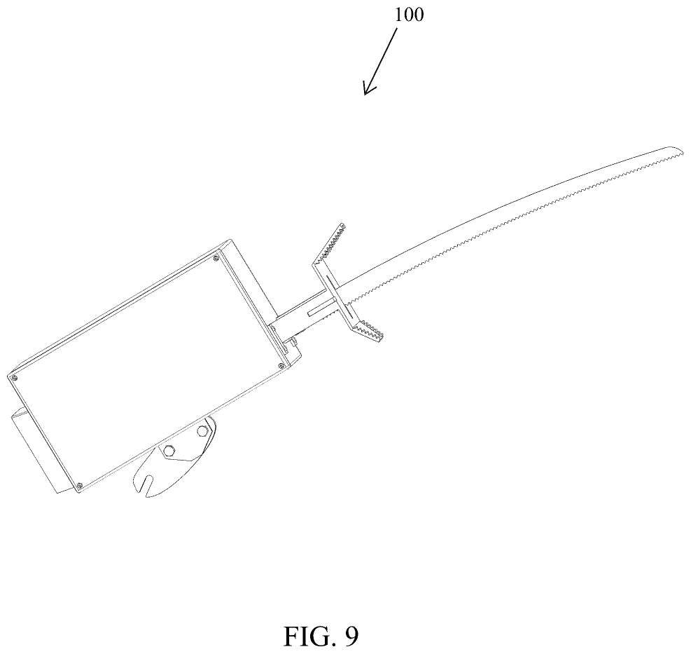

Referring to FIG. 9, FIG. 9 is a perspective view of the present invention, an aerial limb saw 100.

### DETAILED DESCRIPTION

In the Summary of the Invention above and in this Detailed Description, and the Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises”, and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Certain terminology and derivations thereof may be used in the following description for convenience in reference only and will not be limiting. For example, words such as “front”, “back”, “right,” and “left” would refer to directions in the drawings to which reference is made unless otherwise stated. References in the singular tense include the plural, and vice versa, unless otherwise noted.

The present invention is a battery-operated reciprocating saw that is controlled by a wireless remote. An objective of the present invention is to provide users with a device that can be mounted to another object or atop of an insulated lineman's pole to ensure no conductive connection between the operator and the cutting device. The present invention intends to provide users with a device that can reach tree branches on power lines or in hard-to-reach places without sacrificing the operator's safety.

The present invention comprises a housing, a saw system, a battery adapter, and an angled clamp, wherein the housing contains a gear box, a motor, and a wireless control relay. The saw system is integrated within a front surface of the housing. The angled clamp is integrated along a bottom surface of the housing. The battery adapter is integrated into a rear surface of the housing. A wireless remote communicates wirelessly with the wireless control relay contained within the housing. Thus, the present invention is a battery powered reciprocating saw that is remotely controlled and activated, wherein the reciprocating saw is mountable.

The housing is comprised of a metal or a plastic material having a hollow rectangular shape, wherein two sides are equal in width, a first width side is the front surface, and a second width side is the rear surface, and two sides are equal in length, a first length side is a top surface, and a second length side is the bottom surface. The rectangular shape of the housing provides for four corners. Located at each of the four corners of the housing are a threaded screws hole. The threaded screw holes are utilized to attach a housing cover. The housing cover is comprised of a shallow hollowed rectangular shape having two sides equal in width, and two sides equal in length, the width and length of the housing cover sides matching the width and length of the housing sides. The rectangular shape of the housing cover provides for four corners. Located on an outer surface of the housing cover at each of the four corners of the housing cover are through holes for receiving a screw. The through holes are countersunk within the outer surface of the housing cover with a diameter to allow for only a threaded end of a screw to pass through the housing cover. The head of the screw rests on a shelf area of the countersink hole. To attach the housing cover with the housing the through holes of the housing cover are aligned with the threaded screw holes of the housing. Once the housing cover is aligned with the housing, the housing screws are passed through the housing cover and threaded into the threaded screw holes of the housing, thus sealing the interior area of the housing.

The housing contains electronic and mechanical components that go to the function of the present invention. The electronic and mechanical components include a gear box, a motor, and a wireless control relay. The housing comprises a sealed opening positioned along the front surface of the housing in line with the saw system. The gear box is positioned within the housing such that an adapter end of the gear box extends through the sealed opening of the housing. The gear box has integrated mounting bolts on a left side and a right side of the gear box. The gear box is attached to a back surface of the housing via a pair of bolts. The gear box bolts are inserted from an outer surface of the housing through the back surface of the housing and threaded into the integrated gear box bolts to secure the gear box to the back surface of the housing. The adapter end of the gear box includes a linear motion rod. Attached to the linear motion rod is a saw blade chuck. The saw blade chuck receives a saw blade. The saw blade chuck is comprised of a threaded cap. The saw blade has an attachment end, wherein the saw blade chuck accepts the attachment end of the saw blade. The threaded cap of the saw blade chuck rotates clockwise to tighten around the attachment end of the saw and rotates counter clockwise to loosen its hold of the saw blade attachment.

Attached to the front surface of the housing is a grip bracket. The grip bracket is comprised of a metal sheet material having a U-shape. At an open end of the grip bracket are attachment points for attaching the grip bracket to the housing via screws. The grip bracket is positioned on the front surface of the housing such that the adapter end of the gear box is centered between two sides of the grip bracket. The screws are inserted from the outside, passing through the grip bracket attachment points and into the front surface of the housing. A receiving slot is located at a closed end of the grip bracket. The receiving slot is centered with the gear box adapter, wherein the attachment end of the saw blade passes through the receiving slot of the grip bracket and connects with the saw blade chuck. Also located at the closed end of the grip bracket are a top grip component and a bottom grip component. Both the top grip component and the bottom grip component are comprised of a metal material and are welded to the closed end of the grip bracket. The top grip component being located across from a top end of the receiving slot and the bottom grip component being located across from a bottom end of the receiving slot. Together the grip bracket and the saw blade comprise the saw system. In another embodiment, the saw system is comprised of a circular saw. In another further embodiment, the saw system is comprised of a chain saw.

The gear box is a plurality of gears that is mechanically connected to the motor. Together the gear box and the motor are attached and secured to the back surface of the housing via the gear box bolts. The motor may be any DC motor, ideally being a standard 18-volt motor that receives electrical power. The gear box converts a force provided by the motor into a linear motion, wherein the linear motion rod of the gear box moves back and forth and creates the reciprocating motion of the attached saw blade.

Attached to the rear surface of the housing is the battery adapter. Screws are utilized to attach the battery adapter to the housing. The screws are inserted from the outside through the battery adapter and into the housing. The battery adapter receives and connects to a portable rechargeable battery. The battery provides electrical power to the present invention.

The wireless control relay is a various speed control relay utilized to control the speed output of the motor which in turn translates to the speed output of the reciprocating linear motion of the gear box. The wireless control relay is a wireless activated relay that communicates with a wireless remote. The wireless connection allows for the present invention to be operated remotely. The wireless control relay may be a DC wirelessly activated switch. An ideal embodiment is a 40-amp system. The wireless control relay is attached within the interior of the housing to the top surface of the housing. The battery adapter is electrically connected to the wireless control relay by means of a wire connector, wherein battery adapter wires are connected to wires of the wireless control relay. The wireless control relay is also electronically connected to the motor. A second wire connector is utilized to connect wires from the motor with wires of the wireless control relay. A clip clamp is attached to the surface of the wireless control relay on a side opposite of the side attached to the housing. The clip clamp is utilized to hold the wires of the wireless control relay that connect with the battery adapter and wires of the wireless control relay that connect with the motor. Additionally, wire wraps are utilized to secure wires of the wireless control relay that connect with the battery adapter and wires of the wireless control relay that connect with the motor. In a preferred embodiment, the battery adapter and the motor are directly wired to the wireless control relay without relance of a wire connector.

The angled clamp is comprised of a metal material and is positioned along the bottom surface of the housing via a bracket plate. A pair of nuts and bolts are utilized to secure the angled clamp to the bracket plate. The angled clamp is positioned such that it extends away at an angle towards the rear of the present invention. In a preferred embodiment the angled clamp comprises a fastening component in replacement of the C-cut. The fastening component is a means to secure the present invention atop of an insulated pole. Attaching the present invention to an insulated pole allows an operator to place the present invention in hard-to-reach areas while ensuring the safety of the operator such that no electrical connection is created between the operator and the present invention.

Although the invention has been explained in relation to its preferred embodiment, it is to be understood that many other possible modifications and variations can be made without departing from the spirit and scope of the invention.

What is claimed is:

1. A reciprocating saw comprising;
a housing;
a saw system;
an angled clamp;
a battery adapter;
wherein the saw system is integrated into a front surface of the housing; the angled clamp is attached to a bottom surface of the housing; and the battery adapter is attached to a rear surface of the housing.

2. The reciprocating saw as claimed in claim 1, wherein the housing contains a gear box, a motor, and a control relay; the gear box is mechanically connected to the motor, wherein the gear box and motor are attached to a back surface of the housing; and the control relay is attached to a top surface of the housing.

3. The reciprocating saw as claimed in claim 1, wherein the saw system is comprised of a saw blade, and a grip bracket.

4. The reciprocating saw as claimed in claim 3, wherein the saw blade is connected to the gear box; and the grip bracket, wherein the grip bracket is comprised of teeth, is attached to the housing.

5. The reciprocating saw as claimed in claim 2, wherein the motor is connected to the control relay.

6. The reciprocating saw as claimed in claim 2, wherein the battery adapter is connected to the control relay.

7. The reciprocating saw as claimed in claim 2, wherein the control relay is wirelessly connectable.

8. The reciprocating saw as claimed in claim 1, wherein a portable rechargeable battery connects to the battery adapter.

9. The reciprocating saw as claimed in claim 5, wherein a wire connector is utilized to connect the motor to the control relay.

10. The reciprocating saw as claimed in claim 6, wherein a wire connector is utilized to connect the battery adapter to the control relay.

11. The reciprocating saw as claimed in claim 1, wherein the housing includes at least one exhaust port.

12. A reciprocating saw comprising:
a housing, wherein the housing contains a gear box, a motor, and a control relay; the gear box is mechanically connected to the motor, wherein the gear box and motor are attached to a back surface of the housing; the control relay is attached to a top surface of the housing; a saw system, wherein the saw system is comprised of a saw blade and a grip bracket, wherein the grip bracket is comprised of teeth; and a battery adapter, wherein a portable rechargeable battery connects to the battery adapter.

13. The reciprocating saw as claimed in claim 12, wherein the saw blade is connected to the gear box.

14. The reciprocating saw as claimed in claim 12, wherein the grip bracket is attached to the front surface of the housing.

15. The reciprocating saw as claimed in claim 12, wherein the motor is connected to the control relay.

16. The reciprocating saw as claimed in claim 12, wherein the battery adapter is connected to the control relay.

17. The reciprocating saw as claimed in claim 12, wherein the control relay is wireless and wirelessly connectable.

18. The reciprocating saw as claimed in claim 15, wherein a wire connector is utilized to connect the motor to the control relay.

19. The reciprocating saw as claimed in claim 16, wherein a wire connector is utilized to connect the battery adapter to the control relay

20. The reciprocating saw as claimed in claim 12, wherein the housing is comprised of at least one exhaust port.
